(19) United States
(12) Patent Application Publication
(10) Pub. No.: US 2024/0313376 A1
(43) Pub. Date: Sep. 19, 2024

(54) BATTERY ASSEMBLY

(71) Applicant: Hainan Xunwei Technology Co., Ltd., Haikou City (CN)

(72) Inventor: Gonghai FU, Haikou City (CN)

(21) Appl. No.: 18/369,633

(22) Filed: Sep. 18, 2023

(30) Foreign Application Priority Data
Mar. 16, 2023 (CN) 2023205296497

(51) Int. Cl. H01M 50/593; H01M 10/647; H01M 10/658; H01M 50/209; H01M 50/503; H01M 50/522; H01M 50/595

(52) U.S. Cl. CPC H01M 50/593; H01M 10/647; H01M 10/658; H01M 50/209; H01M 50/503; H01M 50/522; H01M 50/595

(57) ABSTRACT

A battery assembly is provided. The battery assembly includes: at least one first battery cell, at least one second battery cell which is stacked with the first battery cell, and at least one first protection member configured for preventing short circuit between the first battery cell and the second battery cell. The first battery cell and the second battery cell each comprise tabs, and the tabs include a first tab and a second tab. One of the first tab and the second tab of the first battery cell is electrically connected to one of the first tab and the second tab of the second battery cell, to form a first series tab assembly.

### CROSS-REFERENCE TO RELATED APPLICATIONS

The present disclosure claims the priority to the Chinese patent application number 2023205296497, filed on Mar. 16, 2023, and entitled “BATTERY ASSEMBLY,” the contents of which are incorporated herein by reference in entirety.

### TECHNICAL FIELD

The present disclosure relates to the field of battery structure, and more particularly, to a battery assembly.

### BACKGROUND ART

Power batteries are usually formed by stacking a plurality of battery cells. At present, a plurality of battery cells in the battery are usually stacked and connected by methods of stacking through a bracket or by fastening through bolts. This stacking and connection method leads to that it is necessary to design and develop corresponding molds, or to provide corresponding bolt holes on each of the battery cells for different battery productions (for example, the number or shapes of battery cells are different), which increases the development cycle and overall production cost of the entire product. In addition, the currently used connection method of the battery cells does not provide any protective effect, and problems such as short circuit may occur between the tabs of the battery cells, which may affect the use safety of the battery.

### SUMMARY

In view of this, an object of the present disclosure is to provide a battery assembly, to solve the problems that the existing connection method of the battery cells of the battery causes that the development cycle and the cost of the battery are higher and short circuit may occur between the tabs.

According to the above-mentioned object, a battery assembly is provided in the present disclosure, wherein the battery assembly includes:
at least one first battery cell;
at least one second battery cell, which is stacked with the at least one first battery cell,
wherein each of the at least one first battery cell and the at least one second battery cell includes tabs, wherein the tabs include a first tab and a second tab, and
one of the first tab and the second tab of the at least one first battery cell is electrically connected to one of the first tab and the second tab of the at least one second battery cell, to form a first series tab assembly; and
at least one first protection member, configured for preventing short circuit between the at least one first battery cell and the at least one second battery cell.

Preferably, at least one side surface of the at least one first battery cell and/or the at least one second battery cell is provided with the at least one first protection member.

Preferably, at least one side surface of two opposite side surfaces of the at least one first battery cell and the at least one second battery cell is provided with the at least one first protection member.

Preferably, each of the at least one first battery cell and the at least one second battery cell includes a first part and a second part, wherein the first part is a concave part of the at least one first battery cell or the at least one second battery cell, the second part is adjacent to the first part; and
at least one side surface of two opposite side surfaces of the second part of the at least one second battery cell and the second part of the at least one first battery cell is provided with the at least one first protection member.

Preferably, the at least one first protection member each includes at least one insulation layer and/or at least one high-temperature resistant layer.

Preferably, the at least one first protection member each further includes at least one adhesive layer.

Preferably, each of the at least one first battery cell and the at least one second battery cell includes a first part and a second part, the first part is a concave part of the at least one first battery cell or the at least one second battery cell, the second part is adjacent to the first part, the at least one first protection member each includes an arm part and a first bending part, and the at least one first protection member is provided between the first part of the at least one first battery cell and the first part of the at least one second battery cell and away from one side of the first series tab assembly.

Preferably, the at least one first protection member each further includes a second bending part.

Preferably, each of the at least one first battery cell and the at least one second battery cell includes a first part and a second part, the first part is a concave part of the at least one first battery cell or the at least one second battery cell, the second part is adjacent to the first part, the battery assembly further includes at least one second protection member, and at least one side surface of the first part of the at least one first battery cell and/or the first part of the at least one second battery cell is provided with the at least one second protection member which is configured for preventing the at least one first battery cell or the at least one second batter cell from being pierced.

Preferably, the at least one second protection member is at least one of a foam and an insulation tape.

Preferably; the at least one second protection member provided on a side where an opening of the concave part is located is the foam, and the at least one second protection member provided on a side away from the opening of the concave part is the insulating tape.

Preferably, a bottom surface and/or at least one side surface of the battery assembly each is provided with a third protection member configured for performing insulation protection.

Preferably, the third protection member is a highland barley paper bonded to a battery cell assembly.

Preferably, an outside of the battery assembly is provided with a fourth protection member that is configured for shrinking a battery cell assembly.

Preferably, the fourth protection member is a polyvinyl chloride (PVC) thermo-shrink film.

Preferably, the battery assembly includes N battery cells, wherein N is a natural number greater than 1; the battery cells each include tabs, wherein the tabs include a first tab and a second tab; the battery assembly further includes an adapting member, which is provided on a top part of the battery assembly, the adapting member includes connecting parts and at least (2N−4) partition parts that are capable of accommodating the tabs and allowing the tabs to pass therethrough, and the connecting parts are each provided between two adjacent partition parts.

Preferably, the partition parts are through holes and/or openings.

Preferably; (N+1) connecting parts are each provided with a soldering part.

Preferably, the N is a natural number greater than 3, the adapting member further includes at least one first convex part, and the at least one first convex part each include at least two partition parts and at least one connecting part.

Preferably, the at least one connecting part in the first convex part is provided with a second convex part on a side thereof facing the battery cells.

Preferably, the battery assembly further includes first connecting members, wherein the first connecting members are provided on the soldering parts, and the first connecting members are configured for connecting the tabs.

Preferably, the first connecting members each are at least one of nickel sheet, copper sheet, and nickel-aluminum alloy sheet.

According to the battery assembly in the present disclosure, by adding the first protection member, short circuit between a plurality of battery cells may be prevented, thereby improving the use safety of the battery; and the first protection member may also enable the plurality of the battery cells to be bonded and stacked to form a battery. Compared to the connection method of stacking through a bracket or fastening through bolts in the prior art, it greatly reduces the product development cycle and cost and there is no need to develop related molds, greatly reducing the development time and cost of flexible packaging battery modules.

In order to make the above-mentioned objects, features and advantages of the present disclosure more obvious and understandable, the preferred embodiments are specially cited below; and in conjunction with the drawings, the detailed description is made as follows.

### BRIEF DESCRIPTION OF DRAWINGS

In order to describe the technical solutions in the embodiments of the present disclosure more clearly, the drawings required to be used in the embodiments are briefly introduced in the following. It should be understood that the following drawings illustrate only certain embodiments of the present disclosure and therefore should not be considered limiting of the scope. For a person of ordinary skill in the art, other related drawings may also be obtained according to these drawings without paying creative efforts.

FIG. 1 is a schematic diagram of a battery cell according to embodiments of the present disclosure;

FIG. 2 is a schematic diagram showing connection of the battery cells and the first protection member according to embodiments of the present disclosure;

FIG. 3 is a schematic diagram of an L-shaped first protection member according to embodiments of the present disclosure;

FIG. 4 is a schematic diagram showing connection of the L-shaped first protection member and the battery cell according to embodiments of the present disclosure;

FIG. 5 is a schematic diagram showing connection of the battery cell and a second protection member according to embodiments of the present disclosure;

FIG. 6 is an explosion diagram showing a battery cell assembly, third protection members and a fourth protection member according to embodiments of the present disclosure;

FIG. 7 is a schematic diagram showing connection of an adapting member and the battery cell assembly according to embodiments of the present disclosure;

FIG. 8 is a schematic diagram of the adapting member according to embodiments of the present disclosure; and

FIG. 9 is another schematic diagram of the adapting member according to embodiments of the present disclosure.

Reference signs: 1—battery cell; 101—first battery cell; 102—second battery cell; 103—battery cell assembly; 11—first part; 12—second part; 13—first tab; 14—second tab; 21—first protection member; 210—arm part; 211—first bending part; 22—second protection member; 221—first foam; 222—insulation tape; 23—third protection member; 24—fourth protection member; 25—second foam; 3—adapating member; 30—partition part; 31—connecting part; 32—first convex part; 33—second convex part; 34—soldering part; 35—first connecting member; 4—cable.

### DETAILED DESCRIPTION OF EMBODIMENTS

The following embodiments are provided to assist the reader in comprehensively understanding of the methods, devices and/or systems described herein. However, various changes, modifications, and equivalents of the methods, devices, and/or systems described herein will be apparent upon understanding the disclosure of the present application. For example, the order of operations described herein is an example only, and is not limited to the order set forth herein, but will be obviously changed after understanding the disclosure of the present application, except for operations that must occur in a particular order. Furthermore, description of features that are known in the art may be omitted for improving clarity and conciseness.

The features described herein may be implemented in different forms and should not be interpreted as limitation to the examples described herein. To be more specifically, the examples described herein are merely used to illustrate some ways of many possible ways of implementing the methods, devices, and/or systems described herein, which will be obvious after understanding the disclosure of the present application.

In the whole specification, when an element (such as a layer, region, or substrate) is described as being “on” another element, “connected to” another element, “coupled to” another element, “above” another element, or “covering” another element, it may be directly “on” another element, “connected to” another element, “coupled to” another element, “above” another element, or “covering” another element, or one or more other elements may exist therebetween. In contrast, when an element is described as being “directly on” another element, “directly connected to” another element, “directly coupled to” another element, “directly above” another element, or “directly covering” another element, there may be no other elements existing therebetween.

As what have been used herein, the term “and/or” includes any one and any combination of any two or more items of the listed related terms.

Although terms such “first”, “second”, and “third” may be used herein to describe various members, assemblies, regions, layers, or parts, these members, assemblies, regions, layers, or parts are not limited by these terms. To be more specific, these terms are merely used to distinguish one member, assembly, region, layer, or part from another member, assembly, region, layer, or part, Therefore, without departing from the teaching of the examples, the first member, assembly, region, layer, or part referred to in the examples described herein may also be referred to as the second member, assembly, region, layer, or part.

For easy description, spatial relationship terms such as “above”, “upper”, “under”, and “lower” may be used herein to describe the relationship between an element and another element as shown in the drawings. Such spatial relationship terms are intended to include different orientations of the device during the usage or operations, in addition to the described orientations in the drawings. For example, when a device in a drawing is turned over, an element that is described as being located “above” another element or at “upper” part with respect to another element is located “under” another element or at “lower” part with respect to another element. Therefore, the term “above” includes two orientations of “above” and “under” according to the spatial orientation of the device. The device may also be oriented in other ways (e.g., the device is rotated 90 degrees or located at other orientations), and the spatial relationship terms used herein are explained accordingly.

There terms used herein are merely used to describe various examples and are not intended to limit the present disclosure. Unless the context clearly states otherwise, the singular form is also intended to include the plural form. The terms “include”, “contain”, and “have” list the existed features, quantities, operations, members, elements and/or their combinations, but does not exclude the existence or addition of one or more other features, quantities, operations, members, elements and/or their combinations.

Due to the manufacturing techniques and/or tolerance, variations in shape shown in the figures may occur. Therefore, the examples described herein are not limited to the specific shapes shown in the figures, but include variations in shapes that occur during the manufacturing.

The features of the examples described herein can be combined in various ways that will be obvious after understanding the disclosure of the present application. Furthermore, although the examples described herein have a variety of configurations, the configurations may be possible if they are obvious after understanding the disclosure of the present application.

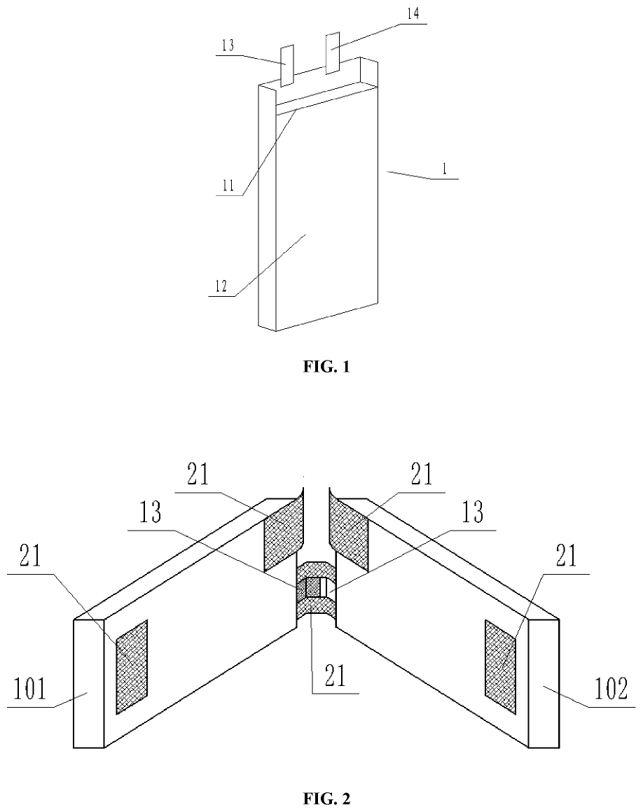

As shown in FIG. 1 to FIG. 9, the battery assembly of the present embodiment includes a plurality of battery cells 1, a plurality of protection members, an adapting member 3 and so forth. In the specification below, the specific configurations of each part of the battery assembly as mentioned above will be described in detail according to the present disclosure.

As shown in FIG. 1, the battery cell 1 in the present embodiment includes a battery cell body, wherein a concave part (that is, the first part 11 as mentioned below) is formed at a first end in the extension direction thereof, and tabs (including a first tab 13 and a second tab 14) of the battery cell 1 is provided at the concave part, which is the inherent structure of the battery cell 1, therefore will not be repeated herein. In order to describe the connection relationships and structures of the following members more accurately, in the present embodiment, the battery cell 1 is divided into the first part 11 and the second part 12 (that is, the concave part above and the second part 12 adjacent to the concave part) in the length direction thereof. In addition, although they are not shown in the figures, when a plurality of battery cells 1 are stacked, the tabs of the two adjacent battery cells 1 are electrically connected, that is, one of the first tab 13 and the second tab 14 of the first battery cell 101 is electrically connected to one of the first tab 13 and the second tab 14 of the second battery cell 102, to form a first series tab assembly.

In the present embodiment, as shown in FIG. 2, the battery assembly includes a plurality of first protection members 21, wherein at least one side surface of the two adjacent battery cells 1 (that is, at least one side surface of the first battery cell 101 and/or the second battery cell 102) is provided with the first protection members 21, so that the first protection members 21 may achieve the technical effect of preventing occurrence of short circuit between the battery cells. Further, at least one side surface of two opposite side surfaces of the two adjacent battery cells 1 (that is, the first battery cell 101 and the second battery cell 102) is provided with the first protection members 21, so that the first protection members 21 may separate the two battery cells, to achieve the effect of preventing occurrence of the short circuit between the battery cells 1. In addition, at least one side surface of the two opposite side surfaces of the second part 12 of the first battery cell 101 and the second part 12 of the second battery cell 102 is provided with the first protection members 21, so that in addition to further enhancing the effect of preventing the short circuit as mentioned above, the first protection members 21 may also play a role of stably bonding the first battery cell 101 and the second battery 102.

Further, as shown in FIG. 2, the first protection members 21 are also provided at the first series tab assembly, so as to avoid short circuit between the first series tab assembly and other electronic components in the battery. Similarly, when a plurality of the battery cells 1 are stacked in series, the tabs of the two battery cells 1 located at two ends in the stacking direction need to be used as the tabs of the entire battery cell assembly 103 to be electrically connected to other electronic components, therefore, the portions where the two tabs and a cable 4 are connected are also provided with the first protection members 21, so as to improve the use safety of the battery assembly. In some examples, the first protection members 21 may cover the first series tab assembly as mentioned above, and may also cover the tabs of one side of the first battery cell 101 away from the first series tab assembly and/or the tabs of one side of the second battery cell 102 away from the first series tab assembly.

Each of the first protection members 21 is formed by combining multiple layers of different materials, but in order to realize the above-mentioned technical effects, the first protection member includes at least one insulation layer and/or at least one high-temperature resistant layer, and in addition, it should also include at least one adhesive layer to facilitate bonding between the first protection member and the battery cell 1. However, the specific components and materials of the first protection member 21 are not specifically limited. For example, in the present embodiment, the first protection member 21 includes a layer of high-temperature resistant tape and a layer of release paper made of glassine paper, so that it has the functions of high-temperature resistance, moisture resistance and oil resistance, etc. In addition, the first protection member 21 is also provided with a layer of insulation tape 222, so that it may achieve the above-mentioned technical effect of preventing the short circuit between the battery cells 1.

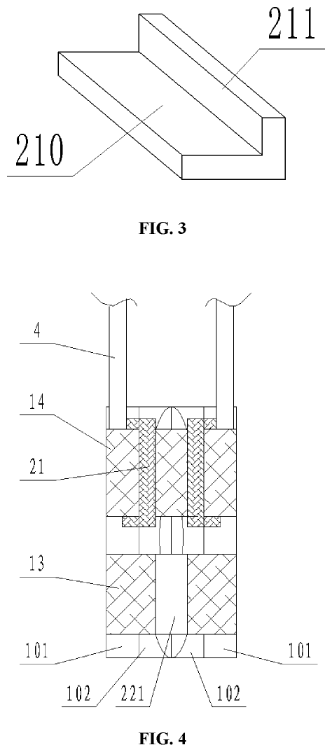

It should be noted that the above-mentioned first protection member 21 is provided as a sheet structure, so that it may be tightly attached to the opposite side part of the adjacent battery cell 1, that is, the first protection member 21 in the sheet structure is convenient to be bonded to each position of the battery cell 1. However, it is not limited thereto, the first protection member 21 provided between the first part 11 of the first battery cell 101 and the first part 11 of the second battery cell 102 and away from one side of the first series tab assembly may also be provided in an L-shaped structure. Specifically, as shown in FIG. 3 to FIG. 4, the first protection member 21 includes an arm part 210 and a first bending part 211, wherein when the first protection member 21 is connected with the first battery cell 101 and the second battery cell 102, the arm part 210 may be correspondingly provided in the concave parts of the first battery cell 101 and the second battery cell 102, and at this time, the first bending part 211 protrudes upwards so that it may be located between the tabs of the first battery cell 101 and the second battery cell 102. During installation, the arm part 210) may be used to carry the tabs of the first battery cell 101 and/or the second battery cell 102, thereby realizing the effect of preventing short circuit between the battery cells 1. Further, although it is not shown in the figures, the first protection member 21 may also be formed into a U-shaped structure. At this time, in addition to the arm part 210 and the first bending part 211, the first protection member 21 further includes a second bending part that is opposite to the first bending part 211.

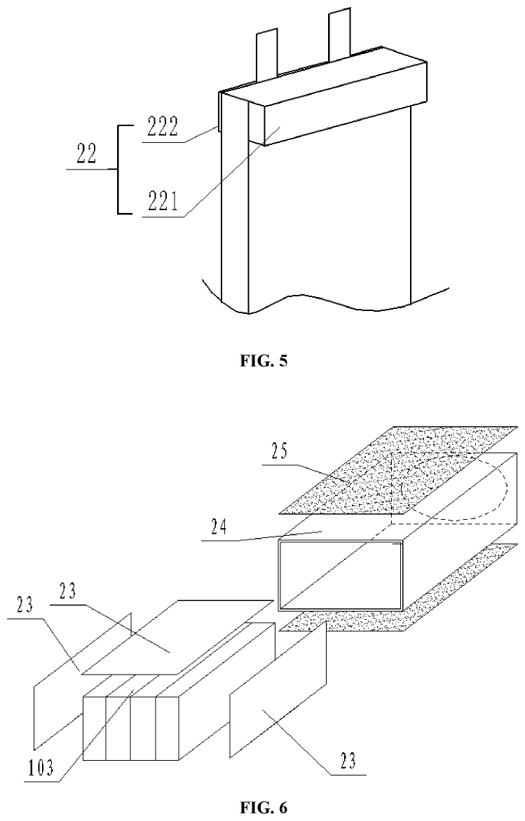

In addition, as shown in FIG. 5, the present battery assembly further includes at least one second protection member 22, wherein at least one side surface of the first part 11 of the first battery cell 101 and/or the first part 11 of the second battery cell 102 is provided with the second protection member 22 for preventing the first battery cell 101 or the second battery cell 102 from being pierced. The second protection member 22 may be one or more of a first foam 221, an insulation tape 222, a high-temperature resistant tape, and a release paper. In the present embodiment, the second protection member 22 includes the first foam 221 and the insulation tape 222, the first foam 221 is provided in the concave part, and the insulation tape 222 is provided at the back of the concave part, that is, the side away from the opening of the concave part. Both the first foam 221 and the insulation tape 222 may prevent the tabs from piercing the aluminum-plastic film after being welded in series, and the first foam 221 may also support the welded tabs.

In addition, as shown in FIG. 6, when a plurality of the battery cells 1 are stacked and connected to form the battery cell assembly 103, the bottom surface of the battery cell assembly 103 (that is, the end surface of the battery cell 1 in the stacking direction) and/or at least one side surface are provided with third protection members 23 for insulation protection, in the present embodiment, each of the third protection members 23 is formed as highland barley paper bonded to the battery cell assembly 103. In addition, an outside of the battery cell assembly 103 is further provided with a fourth protection member 24 for shrinking the battery cell assembly 103, and in the present embodiment, the fourth protection member is formed as a polyvinyl chloride (PVC) thermo-shrink film. A second foam 25 is attached to the outside of the PVC thermo-shrink film, and the second foam 25 is bonded to the housing accommodating the battery cell assembly 103. Because the expansion phenomenon exists during the processes of charging and discharging of the battery cell assembly 103, the second foam 25 is relatively soft, which may provide expansion allowance for the battery cell assembly 103 and has a good shockproof effect, which may protect the battery cell assembly 103 from damage caused by vibration and other reasons.

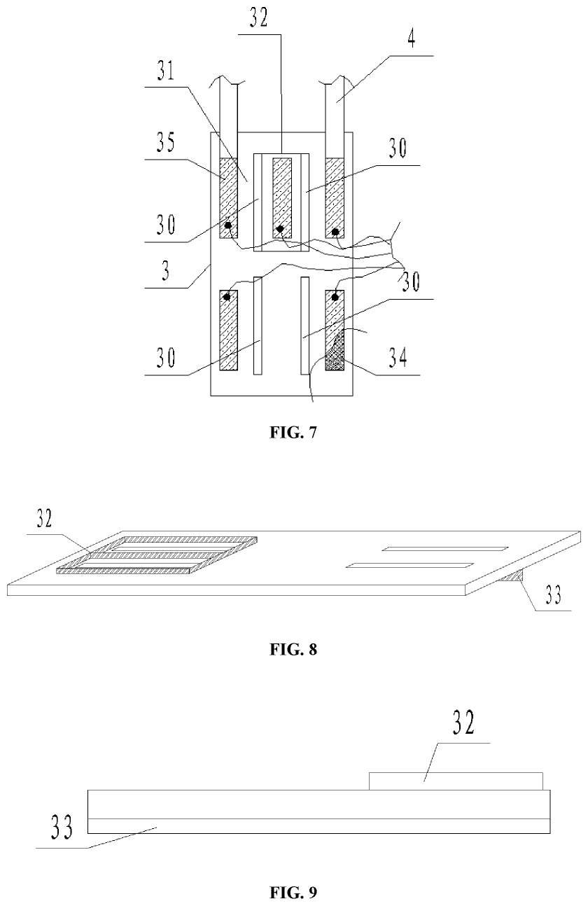

In addition, as shown in FIG. 7 to FIG. 9, the battery cell assembly 103 further includes an adapting member 3 provided on the top part thereof, and the adapting member 3 is provided with connecting parts 31 and partition parts 30. Specifically, when the battery cell assembly 103 includes N battery cells 1 (N is a natural number greater than 1), the number of the partition part 30 is at least (2N−4). The partition parts 30 may accommodate the tabs and allow the tabs of the battery cells 1 to pass therethrough, and the connecting parts 31 are each provided between two adjacent partition parts 30. The form, size, and shape of each of the partition parts 30 are not specifically limited, for example, each of the partition parts 30 may be formed as a hole running through a connecting member or an opening structure, as long as the above-mentioned technical effects may be achieved. In addition, (N+1) connecting parts 31 are each provided with a soldering part 34, so that the tabs of the plurality of the battery cells 1 extend out to the top part of a connecting board through the partition parts 30, and then may be fixed onto the soldering parts 34 by welding, enabling electrical connection of the battery cells 1. In addition, as shown in FIG. 7, a plurality of wires are provided on the top part of each of the battery cells 1 for connection with an external detection device, so as to monitor data such as voltage value, current value, and temperature value of each of the battery cells 1.

Further, as shown in FIG. 8, the battery cell assembly 103 further includes first connecting members 35 that are provided on the soldering parts 34, and the first connecting members 35 each are at least one of nickel sheet, copper sheet, nickel-aluminum alloy sheet and other connecting member with conductive function. During installation, the first connecting members 35 are first connected to the soldering parts 34 of the adapting member 3, and then the adapting member 3 is connected with the tabs of the battery cell assembly 103 by means of laser spot welding or the like.

Further, when the N is a natural number greater than 3, the adapting member 3 further includes at least one first convex part 32, and at least two partition parts 30 and at least one connecting parts 31 are included in the space defined by the first convex part 32. Furthermore, one side, facing the battery cells 11, of the connecting part 31 in the first convex part 32 is provided with a second convex part 33, that is, the first convex part 32 and the second convex part 33 are located at two ends of the connecting member in the thickness direction respectively, and the directions in which the first convex part 32 and the second convex part 33 protrude are opposite to each other. The first convex part 32 and the second convex part 33 may further play a role of separating the tabs of the plurality of the battery cells 1.

According to the battery assembly of the present disclosure, by adding the first protection members 21, short circuit between a plurality of battery cells 1 may be prevented, thereby improving the use safety of the battery. The first protection members 21 may also enable the plurality of battery cells 1 to be bonded and stacked to form a battery. Compared with the connection method of stacking through a bracket or fastening through bolts in the prior art, the product development cycle and cost are greatly reduced, and there is no need to develop related molds, which greatly reduces the development time and cost of the flexible packaging battery modules.

Finally, it should be noted that the above-mentioned embodiments are only the specific embodiment of the present disclosure for illustrating the technical solutions of the present disclosure, rather than limiting it, and the protection scope of the present disclosure is not limited thereto. Although the present disclosure has been described in detail with reference to the afore-mentioned embodiments, it should be understood by those of ordinary skill in the art that: any person familiar with the technical field, within the scope of technology disclosed by the present disclosure, can still modify or can easily think of changing the technical solution described in the foregoing embodiments, or equivalently replace some of the technical features. These modifications, changes or replacements which do not make the essence of the corresponding technical solution deviate from the spirit and scope of the technical solution of the embodiments of the present disclosure should be covered within the protection scope of the present disclosure. Therefore, the protection scope of the present disclosure should be based on the protection scope of the claims.

1. A battery assembly, comprising:
at least one battery cell assembly, each of the at least one battery cell assembly comprising a plurality of battery cells stacked in series, wherein two adjacent battery cells among the plurality of battery cells are a first battery cell and a second battery cell, respectively, each of the at least one battery cell assembly, the first battery cell and the second battery cell comprises tabs, wherein the tabs comprise a first tab and a second tab, and one of the first tab and the second tab of the first battery cell is directly connected to one of the first tab and the second tab of the second battery cell, to form a first series tab assembly; and
cables, wherein the cables are connected with two tabs of each of the at least one battery cell assembly, and
at least one first protection member, at least one of which is provided where the tabs and the cables are connected, covers the tabs and is configured for preventing short circuit of the at least one battery cell assembly.

2. The battery assembly according to claim 1, wherein at least one side surface of the first battery cell and/or the second battery cell is provided with the at least one first protection member.

3. The battery assembly according to claim 2, wherein at least one side surface of two opposite side surfaces of the first battery cell and the at least one second battery cell is provided with the at least one first protection member.

4. The battery assembly according to claim 3, wherein each of the first battery cell and the second battery cell comprises a first part and a second part, wherein the first part is a concave part of the first battery cell or the second battery cell, and the second part is adjacent to the first part; and
at least one side surface of two opposite side surfaces of the second part of the second battery cell and the second part of the first battery cell is provided with the at least one first protection member.

5. The battery assembly according to claim 2, wherein the at least one first protection member each comprises at least one insulation layer and/or at least one high-temperature resistant layer.

6. The battery assembly according to claim 5, wherein the at least one first protection member further comprises at least one adhesive layer.

7. The battery assembly according to claim 1, wherein each of the first battery cell and the second battery cell comprises a first part and a second part, the first part is a concave part of the first battery cell or the second battery cell, the second part is adjacent to the first part, the at least one first protection member each comprises an arm part and a first bending part, and the at least one first protection member is provided between the first part of the first battery cell and the first part of the second battery cell, and at a position away from the first series tab assembly.

8. The battery assembly according to claim 7, wherein the each first protection member further comprises a second bending part.

9. The battery assembly according to claim 1, wherein each of the first battery cell and the second battery cell comprises a first part and a second part, the first part is a concave part of the first battery cell or the second battery cell, the second part is adjacent to the first part, the battery assembly further comprises at least one second protection member, at least one side surface of the first part of the first battery cell and/or the first part of the second battery cell is provided with the at least one second protection member which is configured for preventing the first battery cell or the second battery cell from being pierced.

10. The battery assembly according to claim 9, wherein the at least one second protection member each is at least one of a foam and an insulation tape.

11. The battery assembly according to claim 10, wherein the at least one second protection member provided on a side where an opening of the concave part is located is the foam, and the at least one second protection member provided on a side away from the opening of the concave part is the insulating tape.

12. The battery assembly according to claim 1, wherein a bottom surface and/or at least one side surface of the battery assembly is provided with third protection members that are configured for performing insulation protection.

13. The battery assembly according to claim 1, wherein an outside of the battery assembly is provided with a fourth protection member that is configured for shrinking a battery cell assembly.

14. The battery assembly according to claim 1, wherein the battery assembly comprises N battery cells, wherein the N is a natural number greater than 1; the battery cells each comprise the tabs, wherein the tabs comprise the first tab and the second tab; the battery assembly further comprises an adapting member, which is provided on a top part of the battery assembly, the adapting member comprises connecting parts and at least 2N−4 partition parts configured for accommodating the tabs and allowing the tabs to pass therethrough, and the connecting parts are each provided between two adjacent partition parts.

15. The battery assembly according to claim 14, wherein the partition parts are through holes and/or openings.

16. The battery assembly according to claim 14, wherein N+1 of the connecting parts are each provided with a soldering part.

17. The battery assembly according to claim 14, wherein the N is a natural number greater than 3, the adapting member further comprises at least one first convex part, and the at least one first convex parts each comprise at least two partition parts and at least one connecting part.

18. The battery assembly according to claim 17, wherein the at least one connecting part of the each first convex part is provided, on a side thereof facing the battery cells, with a second convex part.

19. The battery assembly according to claim 16, wherein the battery assembly further comprises first connecting members, wherein the first connecting members are provided on the soldering parts, and the first connecting members are configured for connecting the tabs.

20. The battery assembly according to claim 19, wherein the first connecting members each are at least one of nickel sheet, copper sheet, and nickel-aluminum alloy sheet.
